(19) United States
(12) Patent Application Publication
(10) Pub. No.: US 2015/0346480 A1
(43) Pub. Date: Dec. 3, 2015

(54) GRATING-TYPE TUNABLE FILTER

(71) Applicant: O-NET COMMUNICATIONS (SHENZHEN) LIMITED, Shenzhen, Guangdong (CN)

(72) Inventors: Bin Chen, Shenzhen (CN); Wanying Chen, Shenzhen (CN); Jilong Cao, Shenzhen (CN)

(73) Assignee: O-NET COMMUNICATIONS (SHENZHEN) LIMITED, Shenzhen, Guangdong (CN)

(21) Appl. No.: 14/653,893

(22) PCT Filed: May 14, 2013
(86) PCT No.: PCT/CN2013/075575

§ 371 Date: Jun. 19, 2015

(30) Foreign Application Priority Data
Mar. 6, 2013 (CN) 201320102267.2

(51) Int. Cl. G02B 26/08; G02B 5/30; G02F 1/09; G02B 27/42; G02B 27/30

(52) U.S. Cl. CPC G02B 26/0833; G02B 27/4272; G02B 27/30; G02F 1/09; G02B 5/3083

(57) ABSTRACT

A grating-type tunable filter comprises a signal input terminal, a signal output terminal, a focusing component and gratings. An input collimator, an output collimator, a first grating, a first reflector, a light beam expanding component, a second grating, a polarization rotating component and a second reflector are arranged along an optical path. Wavelength selection is realized by changing the incident angles of the first grating and the second grating by virtue of the rotatable first reflector, and the first grating is inserted among the input collimator, the output collimator and the first reflector driven by MEMS to carry out pre-dispersion.

### TECHNICAL FIELD

The present patent application relates to a tunable filter, and particularly to a miniaturized grating-type tunable filter.

### BACKGROUND

The tunable filter is an instrument used for wavelength selection. It can pick out the light with desired wavelengths from many wavelengths, and deny the light in other wavelengths. As a wavelength-selective device, optical filter is playing an increasingly important role in the optical fiber communication system.

FIG. 1 is an optical path diagram of a present 100 GHZ ITU wavelength tunable optical filter 10. As shown in FIG. 1, the tunable optical filter 10 includes a signal input terminal 113, a signal output terminal 111, a focusing element 13, a grating 15 and a reflector 17. The optical signal inputted from the input terminal 113 converts to parallel light signal through the focusing element 13. The parallel light signal is diffracted at the surface of the grating 15 and directed to the reflector 17. After being reflected by the reflector 17, the light comes back to the original way and finally inputs to the signal output terminal 111. By rotating the grating 15 or reflector 17, the optical signal enters into the grating 15 twice from entering the input terminal 113 to the output terminal 111.

If 50 GHZ ITU wavelength tunable optical filter uses the same optical structure with the above 100 GHZ ITU wavelength tunable optical filter, it will lead to greater diameter of the used lens and larger light spot size of the reflector. The diameter of the corresponding reflector must be increased. The increase of light spot size leads to an increase of the corresponding grating size. The increase of the diameter of the lens, reflector and grating must increase the overall height of the device. It will not only result in decreased versatility of the device but also increase the overall cost of the device comparing with 100 GHZ ITU wavelength tunable optical filter.

### SUMMARY

In view of this, there is a need for a grating-type tunable filter with small size and convenient adjustment.

A grating-type tunable filter includes a signal input terminal, a signal output terminal and a focusing element. An input collimator, an output collimator, a first grating, a first reflector, a light beam expanding component, a second grating, a polarization rotating component and a second reflector are arranged along an optical path. The first reflector is a rotatable reflector. A wavelength selection is realized by changing incident angles of the first grating and the second grating by rotating the rotatable reflector.

In one embodiment, the rotatable reflector is rotatable MEMS reflector or reflector having same functions as the rotatable MEMS reflector. Incident light beam from the input collimator which passes through the first grating, the MEMS reflector, the light beam expanding component, the second grating and the second reflector is received by the output collimator.

In one embodiment, the light beam expanding component is a prism assembly or a lens assembly, a combination of the prism assembly and the lens assembly.

In one embodiment, the input and output collimator is a dual fiber collimator.

In one embodiment, the input and output collimator is a single fiber collimator.

In one embodiment, the polarization rotating element is a quarter-wave plate.

In one embodiment, the polarization rotating element is a Faraday rotation plate.

Since the present patent application uses a small-sized MEMS reflector. In order to increase the number of grating dispersion by the light beam expanding component, the first grating is inserted among the input collimator, the output collimator and the first reflector to carry out pre-dispersion. The large dimension of the second grating due to the rotation of the MEMS reflector is not required. The structure of the second grating is much miniaturized. The change of the waveform of the tunable filter with the wavelength is small. The polarization rotating component is added between the second grating and the second reflector. The polarization state of a light beam passing through the first grating and the second grating at the second time is mutually vertical to the polarization state of the light beam passing through the first grating and the second grating at the first time.

### BRIEF DESCRIPTION OF THE DRAWINGS

The embodiments of the present patent application are further described with reference to the drawings.

FIG. 1 is an optical path diagram of a tunable optical filter of prior art.

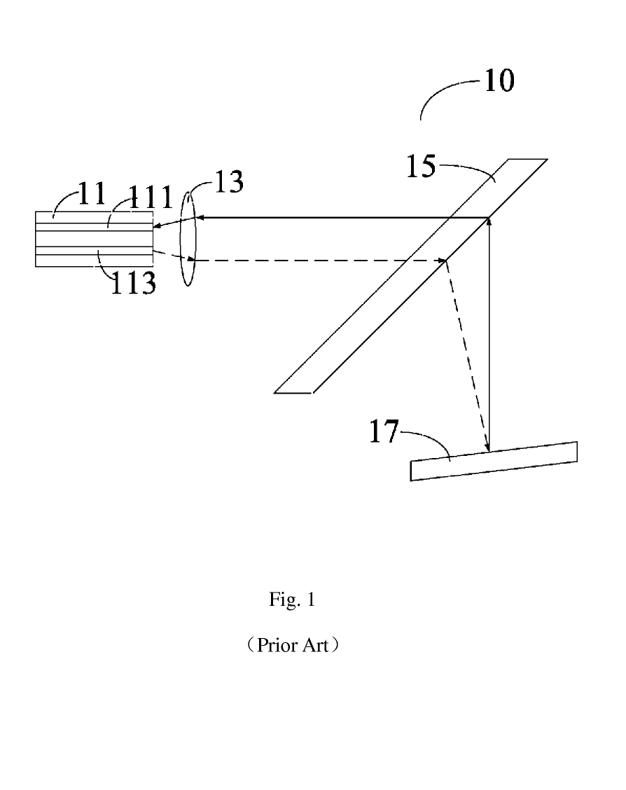

FIG. 2 is an optical path diagram of a grating-type tunable filter according to the first embodiment of the present patent application.

FIG. 3 is an optical path diagram of a grating-type tunable filter according to the second embodiment of the present patent application.

### DETAILED DESCRIPTION

The present patent application will be further described below with reference to the drawings.

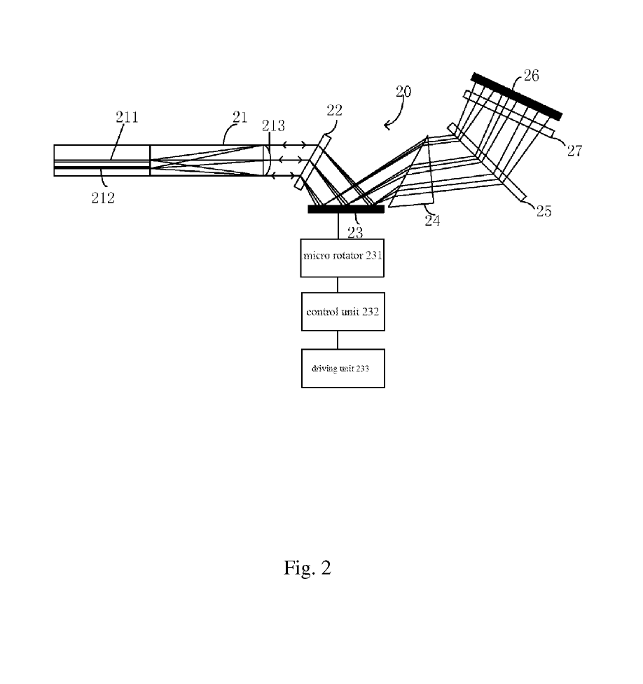

FIG. 2 is an optical path diagram of a grating-type tunable filter according to the first embodiment of the present patent application. The tunable filter 20 includes a dual fiber collimator 21. The dual fiber collimator 21 includes an input fiber 211 and an output fiber 212. A first grating 22, a first reflector 23, a triangular prism 24, a second grating 25, a polarization rotating element 27 and a second reflector 26 are provided along an optical path. The first grating 22 receives input light beam from the input fiber 211 and divides the light beam into different small distance light beam with different wavelength. The different small distance light beam with different wavelength are reflected by the first reflector 23 to the second grating 25. The second grating 25 further divides different small distance light beam based on the wavelength. The polarization state of the further divided light beam is changed by the polarization rotation element 27. Then, the light beam is reflected by the second reflector 26. After passing the polarization rotating element 27, the second grating 25, the triangular prism 24, the first reflector 23 and the first grating 22, the light beam are received by the output fiber 212 of the dual fiber collimator 21. The first reflector 23 is used select the desired wavelength of the optical signal by adjusting to an appropriate angle. The micro rotator 231 is used to control the size of the angle of rotation. The control unit 232 is used to input voltage magnitude signal to the drive unit 233. The driving unit 233 is used to control the rotation angle of the micro rotator 231 according to the received voltage magnitude signal.

Optical principles of the present embodiment is as follows: during the operation, the optical signal input from the input optical fiber 211 is converted to parallel optical signal by the lens 213 in the collimator. The parallel optical signal hits the surface of the first grating 22 and diffracts at the surface. The diffracted optical signal sequentially passes the first reflector 23, the triangular prism 24, the second grating 25, the polarization rotation element 27 and then diffracted again. After being reflected by the second reflector 26, the optical signal returns along the original path, and eventually enters to signal output fiber 212. The optical signal which is inputted from the signal input terminal 211 enters the signal output terminal 212.

In the above-described embodiment, the input fiber 211 and the output fiber 211 can be the dual fiber pigtail type. The spacing between the dual-fiber is adjustable. In this embodiment, the center distance of the dual-fiber is 125 μm.

In the present embodiment, the triangular prism increases the dispersion angle of the received light beam.

In the present embodiment, the polarization rotating element 27 includes a quarter wave plate or Faraday rotator plate for rotating the polarization state of the light beam which pass through the second grating 25.

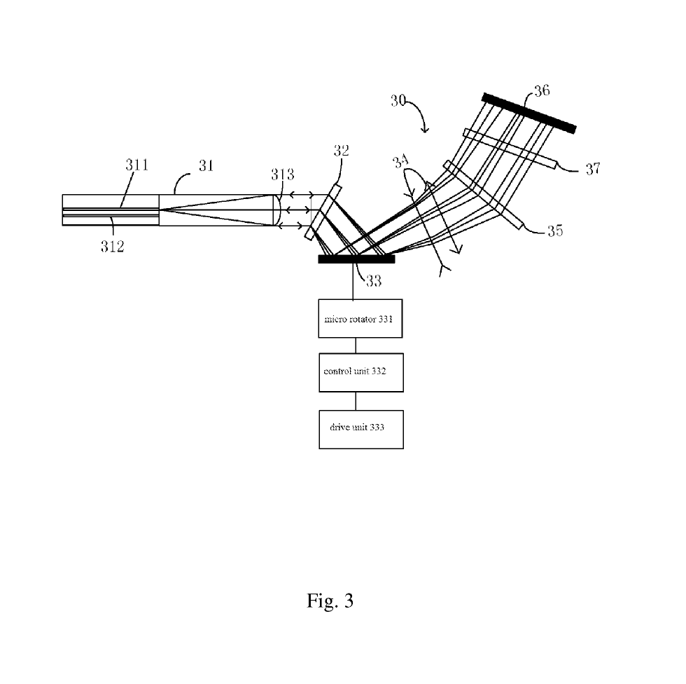

FIG. 3 is an optical path diagram of a grating-type tunable filter according to the second embodiment of the present patent application. The tunable filter 30 includes a dual fiber collimator 31. The dual fiber collimator 31 includes an input fiber 311 and an output fiber 312. A first grating 32, a first reflector 33, a lens assembly 34, a second grating 35, a polarization rotating element 37 and a second reflector 36 are provided along an optical path. The first grating 32 receives input light beam from the input fiber 311 and divides the light beam into different small distance light beam with different wavelength. The different small distance light beam with different wavelength are reflected by the first reflector 33 to the second grating 35. The second grating 25 further divides different small distance light beam according to the wavelength. The polarization state of the further divided light beam is changed by the polarization rotation element 37. Then, the light beam is reflected by the second reflector 36. After passing the polarization rotating element 37, the second grating 35, the lens assembly 34, the first reflector 33 and the first grating 32, the light beam are received by the output fiber 312 of the dual fiber collimator 31. The first reflector 33 is used select the desired wavelength of the optical signal by adjusting to an appropriate angle. The micro rotator 331 is used to control the size of the angle of rotation. The control unit 332 is used to input voltage magnitude signal to the drive unit 333. The driving unit 333 is used to control the rotation angle of the micro rotator 331 according to the received voltage magnitude signal.

Optical principles of the present embodiment is as follows: during the operation, the optical signal input from the input optical fiber 311 is converted to parallel optical signal by the lens 313 in the collimator. The parallel optical signal hits the surface of the first grating 32 and diffracts at the surface. The diffracted optical signal sequentially passes the first reflector 33, the lens assembly 34, the second grating 35, the polarization rotation element 37 and then diffracted again. After being reflected by the second reflector 36, the optical signal returns along the original path, and eventually enters to signal output fiber 312. The optical signal which is inputted from the signal input terminal 311 enters the signal output terminal 312.

In the above-described embodiment, the input fiber 311 and the output fiber 311 can be the dual fiber pigtail type. The spacing between the dual-fiber is adjustable. In this embodiment, the center distance of the dual-fiber is 125 μm.

In the present embodiment, the polarization rotating element 37 includes a quarter wave plate or Faraday rotator plate for rotating the polarization state of the light beam which pass through the second grating 35.

Since the present patent application uses a small-sized MEMS reflector. In order to increase the number of grating dispersion by the prism 24 or lens assembly 34, the first grating is inserted among the input collimator, the output collimator and the first reflector to carry out pre-dispersion. The large dimension of the second grating due to the rotation of the MEMS reflector is not required. The structure of the second grating is much miniaturized. The change of the waveform of the tunable filter with the wavelength is small. The polarization rotating component is added between the second grating and the second reflector. The polarization state of a light beam passing through the first grating and the second grating at the second time is mutually vertical to the polarization state of the light beam passing through the first grating and the second grating at the first time.

The present patent application is described in connection with preferred embodiments. One of ordinary skill in the art should understand that the scope of the present inventions is defined by reference to the claims. Within the spirit and scope of the appended claims and without departing from the patent application as defined, forms and details may be changed.

What is claimed is:

1. A grating-type tunable filter comprising:
a signal input terminal,
a signal output terminal, and
a focusing element,
wherein an input collimator, an output collimator, a first grating, a first reflector, a light beam expanding component, a second grating, a polarization rotating component and a second reflector are arranged along an optical path; and
wherein the first reflector is a rotatable reflector; a wavelength selection is realized by changing incident angles of the first grating and the second grating by rotating the rotatable reflector.

2. The grating-type tunable filter of claim 1, wherein the rotatable reflector is rotatable MEMS reflector or reflector having same function as the rotatable MEMS reflector, incident light beam from the input collimator which passes through the first grating, the MEMS reflector, the light beam expanding component, the second grating and the second reflector is received by the output collimator.

3. The grating-type tunable filter of claim 1, wherein the light beam expanding component is a prism assembly or a lens assembly, or a combination of the prism assembly and the lens assembly.

4. The grating-type tunable filter of claim 1, wherein the input and output collimator is a dual fiber collimator.

5. The grating-type tunable filter of claim 1, wherein the input and output collimator is a single fiber collimator.

6. The grating-type tunable filter of claim 1, wherein the polarization rotating element is a quarter-wave plate.

7. The grating-type tunable filter of claim 1, wherein the polarization rotating element is a Faraday rotation plate.
